(19) United States
(12) Patent Application Publication
(10) Pub. No.: US 2012/0286063 A1
(43) Pub. Date: Nov. 15, 2012

(54) UREA INJECTOR DIAGNOSTICS USING SPECTRAL ANALYSIS FOR SCR NOX REDUCTION SYSTEM

(75) Inventors: Yue-Yun Wang, Troy, MI (US); Stephen Paul Levijoki, Swartz Creek, MI (US)

(73) Assignee: GM GLOBAL TECHNOLOGY OPERATIONS LLC, DETROIT, MI (US)

(21) Appl. No.: 13/105,991

(22) Filed: May 12, 2011

(51) Int. Cl. B67D 7/22; G01M 15/04

(52) U.S. Cl. 239/71; 73/114.51

(57) ABSTRACT

A method to indicate an injector fault in a urea dosing module in an aftertreatment system includes monitoring a control command for the urea dosing module, determining a carry frequency for the control command, monitoring a delivery line pressure for the delivery line, evaluating the delivery line pressure at the carry frequency, and indicating the injector fault based upon the evaluating.

### TECHNICAL FIELD

This disclosure is related to control of aftertreatment of NOx emissions in internal combustion engines.

### BACKGROUND

The statements in this section merely provide background information related to the present disclosure and may not constitute prior art.

Emissions control is one factor in engine design and engine control. One particular emission, NOx, is a known by-product of combustion. NOx is created by nitrogen and oxygen molecules present in engine intake air disassociating in the high temperatures of combustion, and rates of NOx creation include known relationships to the combustion process, for example, with higher rates of NOx creation being associated with higher combustion temperatures and longer exposure of air molecules to the higher temperatures.

NOx molecules, once created in the combustion chamber, can be converted back into nitrogen and oxygen molecules in exemplary devices known in the art within the broader category of aftertreatment devices. Aftertreatment devices are known, for instance, utilizing chemical reactions to treat an exhaust gas flow. One exemplary device includes a selective catalytic reduction device (SCR). An SCR utilizes a reductant capable of reacting with NOx to treat the NOx. One exemplary reductant is ammonia derived from urea injection. A number of alternative reductants are known in the art. Ammonia stored on a catalyst bed within the SCR reacts with NOx, preferably NO₂, and produces favorable reactions to treat the NOx. It is known to operate a diesel oxidation catalyst (DOC) upstream of the SCR in diesel applications to convert NO into NO₂ preferable to treatment in the SCR.

### SUMMARY

A method to indicate an injector fault in a urea dosing module in an aftertreatment system includes monitoring a control command for the urea dosing module, determining a carry frequency for the control command, monitoring a delivery line pressure for the delivery line, evaluating the delivery line pressure at the carry frequency, and indicating the injector fault based upon the evaluating.

### BRIEF DESCRIPTION OF THE DRAWINGS

One or more embodiments will now be described, by way of example, with reference to the accompanying drawings, in which:

FIG. 1. schematically illustrates an exemplary aftertreatment system, in accordance with the present disclosure;

FIG. 2 illustrates an exemplary urea delivery system of an exemplary aftertreatment system including representative command signals, in accordance with the present disclosure;

FIG. 3 illustrates an exemplary control command to a urea dosing module including a PWM duty cycle, in accordance with the present disclosure;

FIG. 4 illustrates a control command and an estimate of resulting urea injection based upon the control command with a consistent pressure in an associated delivery line at a predetermined pressure, in accordance with the present disclosure;

FIG. 5 illustrates a control command as a series of signals alternating between zero and positive values, in accordance with the present disclosure;

FIG. 6 illustrates a spectrum analysis of the PWM duty cycle signal of FIG. 5, in accordance with the present disclosure;

FIG. 7 illustrates a delivery line pressure measured through a period of operation of a urea dosing module according to a PWM duty, in accordance with the present disclosure;

FIG. 8 illustrates a spectrum analysis of the delivery line pressure of FIG. 7, in accordance with the present disclosure;

FIG. 9 illustrates a spectrum analysis of an alternate PWM duty cycle signal, in accordance with the present disclosure;

FIG. 10 illustrates a spectrum analysis of a delivery line pressure corresponding to the operation of the system according to the alternate duty cycle referenced in FIG. 9, in accordance with the present disclosure; and

FIG. 11 illustrates an exemplary process, in accordance with the present disclosure.

### DETAILED DESCRIPTION

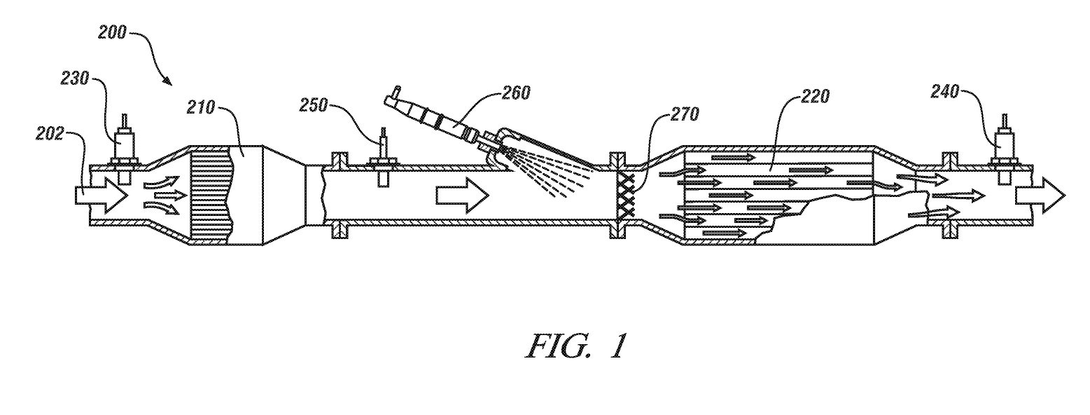

Referring now to the drawings, wherein the showings are for the purpose of illustrating certain exemplary embodiments only and not for the purpose of limiting the same, FIG. 1 illustrates an exemplary aftertreatment system 200. Aftertreatment system 200 includes DOC 210, SCR 220, upstream NOx sensor 230, downstream NOx sensor 240, temperature sensor 250, and urea dosing module 260. Exhaust gas flow 202, resulting from an upstream internal combustion engine, enters aftertreatment system 200. DOC 210 performs a number of catalytic functions in the aftertreatment of the exhaust gas flow. One of the functions of DOC 210 is to convert NO, a form of NOx not readily treated in an SCR, into NO₂, a form of NOx more readily treated in an SCR. SCR 220 utilizes urea as a reactant to reduce NOx into other, more desirable molecules. Upstream NOx sensor 230 detects and quantifies NOx in the exhaust gas flow entering aftertreatment system 200. Upstream NOx sensor 230 quantifies NOx entering the aftertreatment system. NOx entering the system can be quantified for use in evaluating conversion efficiency in an SCR by other means, for example, through a NOx sensor located between DOC 210 and SCR 220 or through a virtual NOx sensor modeling engine output and conditions within the exhaust gas flow to estimate the presence of NOx entering the aftertreatment system. A sensor input can be monitored indicative of NOx entering the aftertreatment system in accordance with the exemplary embodiment. Or, depending upon upstream sensor placement, a sensor input can be monitored indicative of NOx content entering a portion of the aftertreatment system. SCR 220 utilizes ammonia derived from injected urea to convert NOx to more desirable molecules by methods known in the art. Temperature sensor 250 is located in a region to gather exhaust gas flow temperatures within the aftertreatment system 200. Urea dosing module 260 is located in a position upstream of SCR 220. The urea can be directly sprayed into the exhaust gas flow entering the SCR. A mixer device 270 can be utilized to receive the urea spray. Urea dosing module 260 injects urea onto mixer device 270, and the urea is then carried by the exhaust gas flow in a substantially even distribution onto the catalyst surfaces on the interior of SCR 220. Downstream NOx sensor 240 detects and quantifies NOx in the exhaust gas flow exiting aftertreatment system 200. NOx sensors can be cross sensitive to ammonia. Methods are known to distinguish sensor readings between NOx, ammonia, and a mix of the two in order to correctly diagnose operation of the SCR device. A method is known to utilize a measure of the NOx entering the aftertreatment system and a measure of the NOx exiting the aftertreatment system to determine the conversion efficiency of the NOx into more desirable molecules within aftertreatment devices.

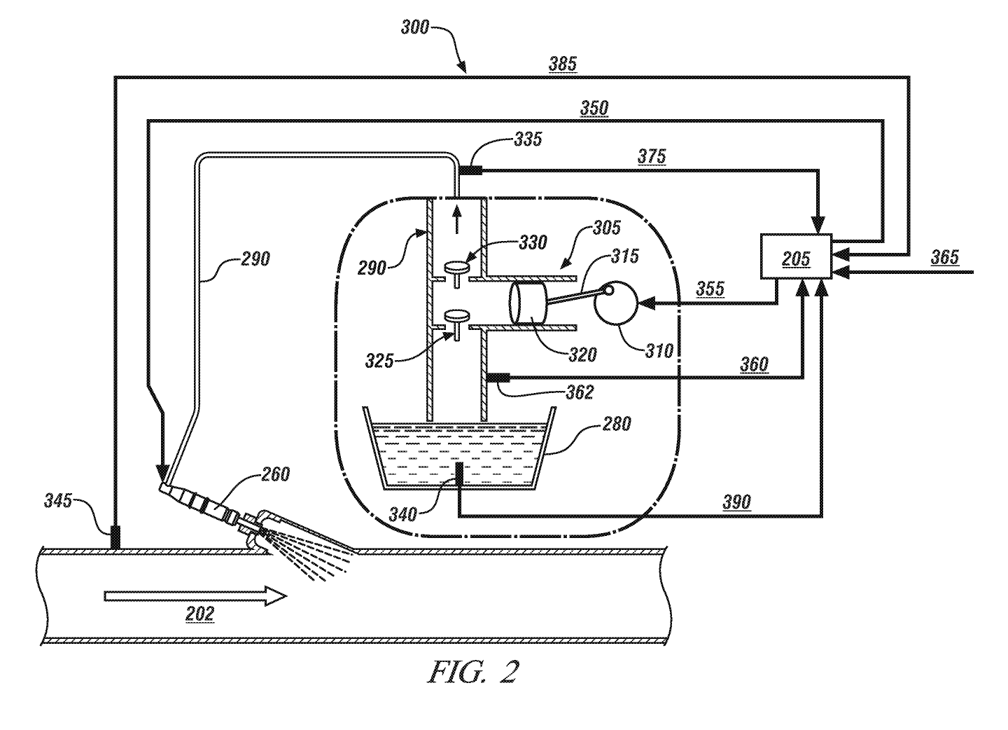

FIG. 2 illustrates an exemplary urea delivery system 300 of the exemplary aftertreatment system 200 including representative command signals. The urea delivery system 300 includes storage tank 280, pump 305 and dosing module 260 interconnected by the delivery line 290. The storage tank 280 is positioned in the vehicle to provide access to the storage tank 280 for refilling. The pump 305 can be located either internally or externally to the storage tank 280. The pump 305 includes a motor 310 or alternate drive for providing rotation to a pump crankshaft 315. The crankshaft 315 is interconnected to a pump piston 320 and converts rotational motion of the motor 310 to linear motion at the piston 320 and cycles between an intake and exhaust stroke. The pump 305 also includes injection valves 325 and 330 for controlling the flow of urea from the tank 280 to the delivery line 290 and creating pressure therein. The intake stroke occurs as the piston 320 is moved away from valves 325, 330 and toward the crankshaft 315. The exhaust stroke occurs as the piston 320 is moved toward valves 325, 330 and away from the crankshaft 315. The description of the pump 305 is illustrative of one embodiment, but the disclosure is not intended to be limited thereto. For example, the pump 305 may have one of valves 325, 330 and not the other to control the pressure in the delivery line 290.

The pump 305 is operatively connected to control module 205 for controlling the operation of the pump 305. The control module 205 controls pump 305 through a pulse width modulation (PWM) duty cycle signal 355. The control module 205 receives temperature information 390 either provided by a temperature sensor 340 located in the storage tank 280 or calculated from known atmospheric conditions. Likewise, the control module 205 receives ambient pressure 360 either from an intake pressure sensor 362 located before valve 325, an ambient pressure sensor remotely located, or calculated from known atmospheric conditions. Desired line pressure 365 can be determined as a set value. The control module 205 receives pressure feedback 375 information from a pressure sensor 335 downstream of valve 330 and controls urea dosing module 260 by controlling the displacement of a pin located in the orifice by the control command 350. The control module 205 can determine a pressure 385 of exhaust gas flow 202 in the aftertreatment system 200 either through calculation or as direct pressure sensor information from pressure sensor 345 located in the aftertreatment system 200 or elsewhere in the exhaust system.

During operation, the engine is operating and producing exhaust requiring treatment within the aftertreatment system 200. Control module 205 monitors information regarding the operation of the engine and determines how much urea must be injected into the aftertreatment system 200 (i.e. a desired urea injection). Control module 205 monitors the temperature 390 of the urea in the tank 208 and ambient pressure 360 and determines the required pump PWM duty cycle signal 355 to create a predetermined pressure 370 in the delivery line 290. Control module 205 can additionally or alternatively include feedback control to create the predetermined pressure 370 in the delivery line 290 based upon pressure feedback 375. In accordance with one embodiment, the predetermined pressure 370 can be set to 5 bar or 5,000 mbar. The control module 205 generates control command 350, operating urea dosing module 260 such that the pressurized urea in delivery line 290 will deliver the desired urea injection.

The SCR device includes surfaces coated with a catalyst, and a proper amount of urea in the presence of the exhaust gas flow in a correct temperature range permits treatment of the exhaust gas flow. If the SCR catalyst is damaged or degraded, the SCR function will be adversely affected. If the injection includes contaminants or does not include urea, the SCR function will be adversely affected. If the injector fails to operate correctly or an injector fault occurs, then the SCR function will be adversely affected. An injector fault can be caused by a number of factors including a clogged injector, a failure of an actuator device actuating the dosing module, or a failure of the control command 350 to reach the dosing module.

Urea injection through the urea dosing module 260 is performed over time to replenish urea as it is consumed by the treatment process. According to a solenoid activated urea dosing module 260 wherein the solenoid activating the injection to a known injection setting and according to operation of the urea within delivery line 290 at a predetermined pressure, activation of the urea dosing module 260 will result in an injection of urea at a predictable or estimable flow rate. An exemplary method to inject urea includes operating the urea dosing module with a control command including a PWM duty cycle calibrated to deliver a desired amount of urea per unit time. Operation according to a PWM duty cycle can include periodic on and off operation. This periodic operation can be represented by a carry frequency.

Prior to activation of the urea dosing module 260, the urea within delivery line 290 can reach a steady state condition at the predetermined pressure. Upon activation of the urea dosing module 260, the release of urea through the urea dosing module 260 will cause the pressure within delivery line 290 near the dosing module to drop. Further, the release of urea will result in a disturbance of the urea within the delivery line 290 traveling through the delivery line 290. Based upon periodic operation of the urea dosing module 260 at the carry frequency, the resulting disturbance is generated and propagated through the delivery line 290 at the carry frequency. Under certain conditions, the disturbance can be analyzed by monitoring variation in the delivery line pressure of the delivery line 290. If the delivery line pressure is varying at the carry frequency, a determination can be made that the urea dosing module is operating properly or that there is no injector fault. If the is not varying at the carry frequency, under the correct conditions, a determination can be made that the urea dosing module is not operating correctly or there is an injector fault.

Determining the carry frequency of the control command and determining whether the delivery line pressure is varying at the carry frequency. In accordance with one embodiment, a signal can be analyzed in the time domain. By analyzing behavior of the signal through a time period, a period of repetition of the signal can be determined. Frequency is an inverse of the period of a signal. One method to determine the period of a signal is to pick a recurring point of a waveform and use that point on each repeating wave to measure the time between each point. An exemplary point to measure a waveform at is each time the signal increases through a level halfway between the signal minimum and signal maximum. If a signal is approximately at steady state, with stable minimum and maximum values, a fixed value defining the level halfway between the signal minimum and signal maximum can be used. If the signal is not at steady state, a minimum and maximum value can be used for each wave of the waveform to determine the level halfway between the signal minimum and signal maximum for each wave. A number of methods to measure a period of a waveform in a time domain may be employed by one having ordinary skill in the art, and the disclosure is not intended to be limited to the particular exemplary embodiments provided herein.

In accordance with another embodiment, a signal can be analyzed in the frequency domain. Spectrum analysis is an analysis method used to analyze a frequency response of a system in the frequency domain. Applying spectrum analysis to signals from pressure sensor 335 in the delivery line 290, a determination can be made whether delivery line pressure in the delivery line 290 is varying at the carry frequency. One exemplary method of spectral analysis utilizes a fast Fourier transform to analyze the signal through a range of frequencies. When analyzing a delivery line pressure, wherein a carry frequency for the control command is already known, a point fast Fourier transform can be utilized to analyze the delivery line pressure at the carry frequency. Fast Fourier transforms and point fast Fourier transforms are known in the art and will not be discussed in detail herein.

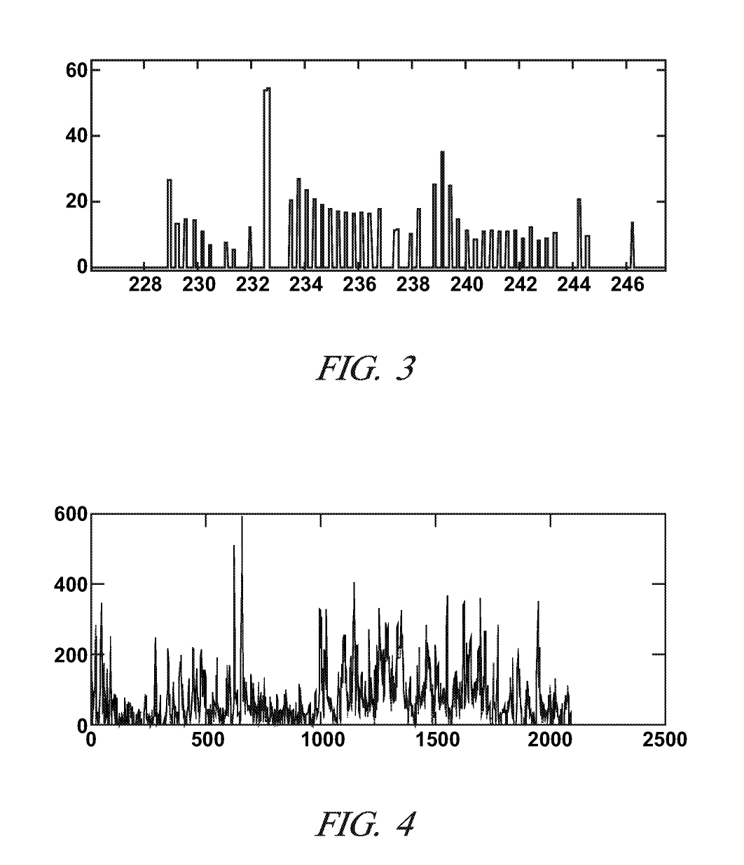

FIG. 3 illustrates an exemplary control command to a urea dosing module including a PWM duty cycle. The x-axis represents a time in seconds. The y-axis represents a percentage to which the urea injection module is activated. The plot illustrates opening and closing of the valve of the urea injection module according to the PWM duty cycle. The PWM duty cycle can include injection events timed at regular or approximately regular intervals for which a period of the signal during the regular intervals can be determined or estimated.

FIG. 4 illustrates a control command and an estimate of resulting urea injection based upon the control command with a consistent pressure in an associated delivery line at a predetermined pressure. The x-axis represents a time in seconds. The y-axis represents a urea injection in mg/second. The solid plot represents a urea injection command for a desired urea injection, and the dotted line represents an estimated urea injection based upon a line pressure set at a predetermined pressure without disturbance. With no disturbance, the estimated urea injection closely tracks the urea injection command.

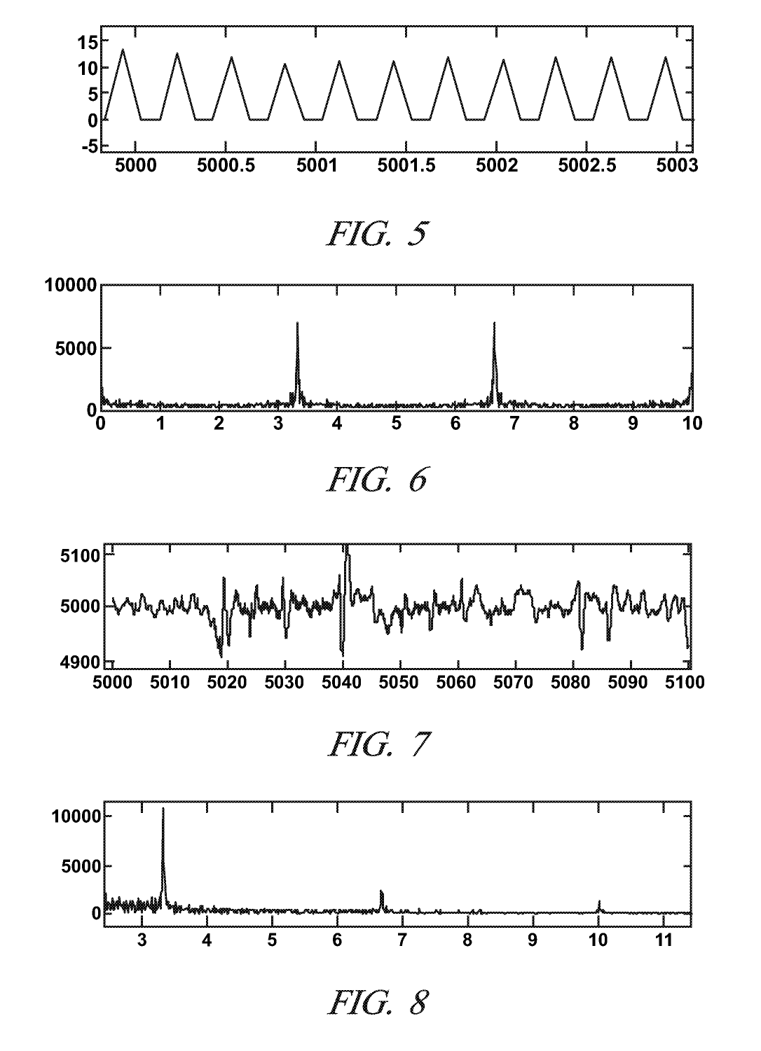

FIG. 5 illustrates a control command as a series of signals alternating between zero and positive values. The x-axis represents a time in seconds. The y-axis represents a percentage to which the urea injection module is activated. The waveform illustrates in close detail an exemplary PWM duty cycle signal examined as periodic positive signal through a time period. The illustrated waveform can be measured to express a period of just under a third of a second or a frequency of just over 3 Hz.

FIG. 6 illustrates a spectrum analysis of the PWM duty cycle signal of FIG. 5. The x-axis represents frequencies in Hz. The y-axis represents a magnitude of the signal determined to be varying at any particular frequency. Corresponding to the repetition or the frequency of the positive values of the PWM duty cycle signal, FIG. 6 illustrates a peak at a frequency of just over 3 Hz corresponding to the signal of FIG. 5. Additionally, a second peak is depicted at a frequency of two times the first peak resulting from a particular analysis method. If a plurality of peaks is identified, the lowest frequency peak can be selected to express the carry frequency of the signal being analyzed.

Identifying a peak can be performed according to a number of methods known in the art. A calibrated threshold value can be utilized to determine a peak. For example, in FIG. 6 a magnitude value of 3,000 can be selected, whereat any value greater than the calibrated threshold value can be identified as a peak. A peak can alternatively be identified by comparison to points at neighboring frequencies. An incremental frequency value or an increment away from the carry frequency that can distinguish a peak from a near zero value can be selected or calibrated. A magnitude value at a first frequency, the carry frequency, can be divided by a magnitude value at a second frequency above or below the first frequency by the increment and comparing the resulting magnitude ratio to a threshold ratio. If the magnitude ratio is greater than the threshold ratio, then the first frequency represents a peak.

FIG. 7 illustrates a delivery line pressure measured through a period of operation of a urea dosing module according to a PWM duty cycle. The x-axis represents a time in seconds. The y-axis represents the delivery line pressure in mbar. A PWM duty cycle signal similar to the signal depicted in FIG. 5 is used to control the system through a 100 second time span. The system includes a predetermined pressure of 5,000 mbar. As a result of operation of the urea delivery module, disturbance in the delivery line causes the pressure to vary.

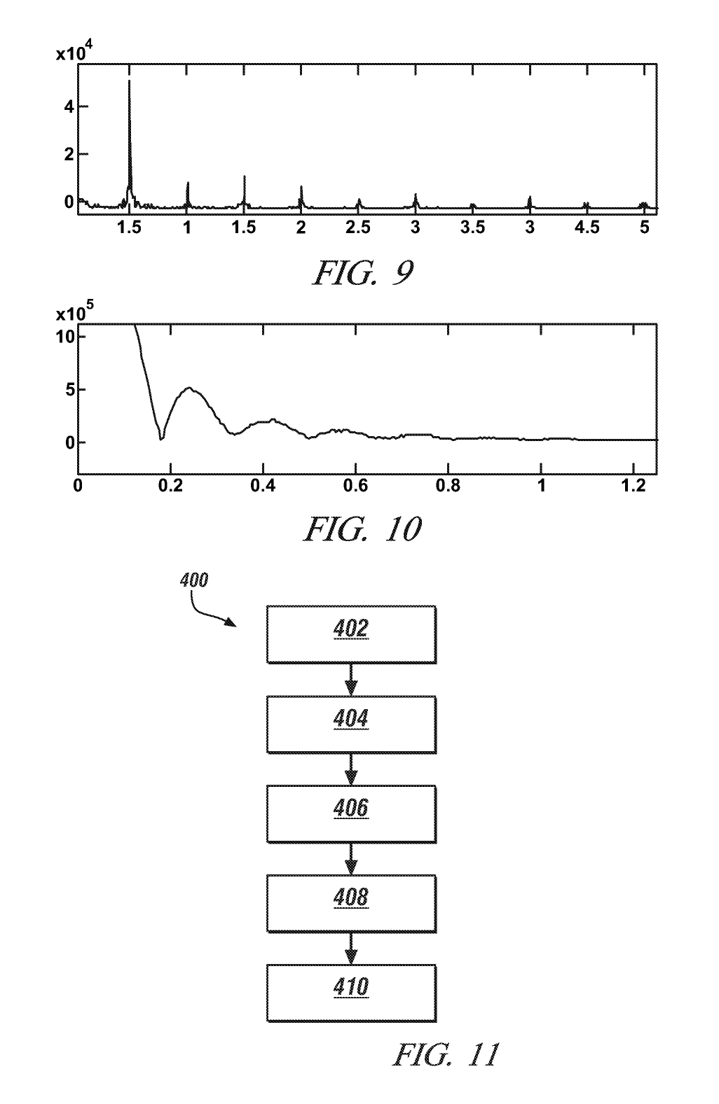

FIG. 8 illustrates a spectrum analysis of the delivery line pressure of FIG. 7. The x-axis represents frequencies in Hz. The y-axis represents a magnitude of the signal determined to be varying at any particular frequency. Corresponding to the frequency of the delivery line pressure variations, FIG. 8 illustrates a peak at a frequency of just over 3 Hz corresponding to the signal of FIG. 7. This peak frequency indicates a frequency for the fluid within the delivery line. A comparison of the frequencies identified by the peaks of FIGS. 7 and 9 can be used to determine that the delivery line pressure is varying at the carry frequency. This comparison can be used to indicate that the associated urea dosing module is operating properly.

FIG. 9 illustrates a spectrum analysis of a different PWM duty cycle signal. The x-axis represents frequencies in Hz. The y-axis represents a magnitude of the signal determined to be varying at any particular frequency. The spectrum analysis identifies a peak at a frequency of approximately 0.5 Hz. The carry frequency of this control command can be expressed as 0.5 Hz.

FIG. 10 illustrates a spectrum analysis of a delivery line pressure corresponding to the operation of the system according to the duty cycle of FIG. 9. The x-axis represents frequencies in Hz. The y-axis represents a magnitude of the signal determined to be varying at any particular frequency. FIG. 10 does not identify any peak in the area of 0.5 Hz. A comparison of the carry frequency identified by the peak of FIG. 9 and lack of a corresponding peak in FIG. 10 can be used to identify that the delivery line pressure is not varying at the carry frequency. This comparison can be used to indicate that the associated urea dosing module is not operating properly or to indicate an injector fault.

A number of conditions can affect an analysis of the delivery line pressure accurately indicating an injector fault. For example, the predetermined pressure of the delivery line needs to exceed a minimum delivery line pressure such that disturbance in the delivery line is propagated through the delivery line. Above a minimum delivery line pressure, the average pressure within the delivery line is a fixed value. Below a minimum delivery line pressure, the pressure within the delivery line includes a pressure drop from the pump to the urea dosing module. In the exemplary configuration of FIG. 2, an exemplary minimum delivery line pressure was determined to be approximately 3,000 mbar. Another exemplary condition that can affect an analysis of the delivery line pressure accurately indicating an injector fault includes the percentage to which the urea injection module is activated. If the percentage to which the urea injection module is activated is smaller than a minimum percentage threshold, then the disturbance caused by the urea dosing module can be too small to accurately measure with the pressure sensor. Different configurations will require different minimum percentage thresholds. In the exemplary configuration of FIG. 2, an exemplary minimum percentage was indicated between 5% and 10%.

FIG. 11 illustrates an exemplary process in accordance with the present disclosure. Table 1 provides a key for FIG. 11.

TABLE 1

| Block | Description |
|---|---|
| 402 | Monitor a Control Command for a Urea Dosing Module |
| 404 | Determine a Carry Frequency for the Control Command |
| 406 | Monitor a Delivery Line Pressure for a Delivery Line |
| | Connected to the Urea Dosing Module |
| 408 | Evaluate the Delivery Line Pressure at the Carry Frequency |
| 410 | Indicating an Injector Fault Based Upon the Evaluation |

Process 400 begins at block 402 by monitoring a control command for the urea dosing module. At block 404, the process utilizes a method disclosed herein to determine a carry frequency for the control command. At block 406, the process monitors a delivery line pressure for the delivery line. At block 408, the process utilizes a method disclosed herein to evaluate whether the delivery line pressure is varying at the carry frequency. At block 410, the process indicates an injector fault based upon the evaluation. A number of processes to utilize the methods disclosed herein are envisioned, and the disclosure is not intended to be limited to the particular exemplary embodiments provided.

Upon indicating an injector fault or an improperly operating urea dosing module, a number of actions or remedies can be implemented. A warning can be generated and displayed to the operator of the vehicle, stored in a diagnostic log for use in servicing the vehicle, or utilized in an adaptive control scheme. An injector fault indicating that the urea dosing module is likely to be injecting insufficient urea can be utilized to increase the PWM duty cycle, such that any remaining injection capability can make up for the injector fault. If the injector is blocked, a series of high percentage or 100% pulses can be used to potentially clear the block. If the methods herein indicate a properly operating urea dosing module, no action need be taken. In another embodiment wherein a separate indication has been made that an SCR device is failing to adequately treat NOx in the exhaust gas stream, an indication of a properly operating urea dosing module can be utilized to initiate or operate a non-injector-fault diagnostic to determine a cause for the SCR device failure.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Method to indicate an injector fault in a urea dosing module in an aftertreatment system, the method comprising:
monitoring a control command for the urea dosing module;
determining a carry frequency for the control command;
monitoring a delivery line pressure for the delivery line;
evaluating the delivery line pressure at the carry frequency; and
indicating the injector fault based upon the evaluating.

2. The method of claim 1, wherein evaluating the delivery line pressure at the carry frequency comprises:
utilizing spectral analysis to determine a magnitude for the delivery line pressure at the carry frequency; and
comparing the magnitude for the delivery line pressure at the carry frequency to a threshold magnitude; and
wherein indicating the injector fault based upon the evaluating comprises indicating the injector fault based upon the magnitude for the delivery line pressure at the carry frequency being less than the threshold magnitude.

3. The method of claim 2, wherein utilizing the spectral analysis to determine the magnitude for the delivery line pressure at the carry frequency comprises utilizing fast Fourier transform of the delivery line pressure across a range of frequencies.

4. The method of claim 2, wherein utilizing the spectral analysis to determine the magnitude for the delivery line pressure at the carry frequency comprises utilizing a point fast Fourier transform of the delivery line pressure at the carry frequency.

5. The method of claim 1, wherein evaluating the delivery line pressure at the carry frequency comprises:
utilizing spectral analysis to determine a magnitude for the delivery line pressure at the carry frequency;
utilizing spectral analysis to determine a magnitude for the delivery line pressure at an increment away from the carry frequency;
comparing the magnitude for the delivery line pressure at the carry frequency to the magnitude for the delivery line pressure at the increment away from the carry frequency; and
wherein indicating the injector fault based upon the evaluating comprises indicating the injector fault based upon dividing the magnitude for the delivery line pressure at the carry frequency by the magnitude for the delivery line pressure at the increment away from the carry frequency and comparing a result of the dividing to a threshold magnitude ratio.

6. The method of claim 1, wherein determining the carry frequency for the control command comprises:
determining a period of the control command; and
determining the carry frequency as the inverse of the period of the control command.

7. The method of claim 1, wherein determining the carry frequency for the control command comprises:
utilizing spectral analysis of the control command to determine the carry frequency.

8. The method of claim 7, wherein utilizing spectral analysis of the control command comprises:
utilizing fast Fourier transform of the control command through a range of frequencies.

9. The method of claim 7, wherein utilizing spectral analysis of the control command to determine the carry frequency comprises:
identifying peaks in the spectral analysis in excess of a magnitude threshold;
selecting a lowest frequency peak from the identified peaks; and
utilizing the lowest frequency peak to determine the carry frequency.

10. The method of claim 1, further comprising:
operating a non-injector-fault diagnostic based upon the evaluating indicating proper operation of the urea dosing module.

11. The method of claim 10, wherein the evaluating indicating the proper operation of the urea dosing module comprises:
determining the delivery line pressure to be varying at the carry frequency.

12. Method to evaluate operation of a urea dosing module in an aftertreatment system, the method comprising:
monitoring a control command for the urea dosing module comprising a pulse width modulation duty cycle;
monitoring a delivery line pressure for a delivery line operably connected to the urea dosing module;
determining a carry frequency for the control command;
determining a variation of the delivery line pressure;
when the variation of the delivery line pressure occurs at the carry frequency, indicating proper operation of the urea dosing module; and
when the variation of the delivery line pressure does not occur at the carry frequency, indicating improper operation of the urea dosing module.

13. Apparatus to indicate an injector fault in a urea dosing module in an aftertreatment system, the apparatus comprising:
the urea dosing module;
a delivery line operatively connected to the urea dosing module;
a pressure sensor monitoring a delivery line pressure for the delivery line; and
a control module:
monitoring a control command for the urea dosing module;
determining a carry frequency for the control command;
monitoring the pressure sensor;
evaluating the delivery line pressure at the carry frequency; and
indicating the injector fault based upon the evaluating.

14. The apparatus of claim 13, wherein evaluating the delivery line pressure at the carry frequency comprises:
utilizing spectral analysis to determine a magnitude for the delivery line pressure at the carry frequency; and
comparing the magnitude for the delivery line pressure at the carry frequency to a threshold magnitude; and
wherein indicating the injector fault based upon the evaluating comprises indicating the injector fault based upon the magnitude for the delivery line pressure at the carry frequency being less than the threshold magnitude.

15. The apparatus of claim 14, wherein utilizing spectral analysis to determine the magnitude for the delivery line pressure at the carry frequency comprises utilizing fast Fourier transform of the delivery line pressure across a range of frequencies.

16. The apparatus of claim 14, wherein utilizing spectral analysis to determine the magnitude for the delivery line pressure at the carry frequency comprises utilizing a point fast Fourier transform of the delivery line pressure at the carry frequency.

17. The apparatus of claim 13, wherein evaluating the delivery line pressure at the carry frequency comprises:
utilizing spectral analysis to determine a magnitude for the delivery line pressure at the carry frequency;
utilizing spectral analysis to determine a magnitude for the delivery line pressure at an increment away from the carry frequency;
comparing the magnitude for the delivery line pressure at the carry frequency to the magnitude for the delivery line pressure at the increment away from the carry frequency; and
wherein indicating the injector fault based upon the evaluating comprises indicating the injector fault based upon dividing the magnitude for the delivery line pressure at the carry frequency by the magnitude for the delivery line pressure at the increment away from the carry frequency and comparing a result of the dividing to a threshold magnitude ratio.

18. The apparatus of claim 13, wherein determining the carry frequency for the control command comprises:
determining a period of the control command; and
determining the carry frequency as the inverse of the period of the control command.

19. The apparatus of claim 13, wherein determining the carry frequency for the control command comprises:
utilizing spectral analysis of the control command to determine the carry frequency.

20. The apparatus of claim 19, wherein utilizing spectral analysis of the control command comprises:
utilizing fast Fourier transform of the control command through a range of frequencies.
